(19) United States
(12) Patent Application Publication
(10) Pub. No.: US 2001/0046605 A1
(43) Pub. Date: Nov. 29, 2001

(54) Refractory coating for components of an aluminium electrolysis cell

(76) Inventors: Jean-Paul Huni, Jonquiere (CA); Kwat I. The, Brockville (CA); Amir A. Mirtchi, Jonquiere (CA); Jules Bergeron, Jonquiere (CA)

Correspondence Address: Christopher C. Dunham, c/o Cooper & Dunham LLP, 1185 Ave. of the Americas, New York, NY, 10036, US

(21) Appl. No.: 09/777,588

(22) Filed: Feb. 6, 2001

Related U.S. Application Data
(60) Provisional application No. 60/183,063, filed on Feb. 16, 2000.

(51) Int. Cl. B32B 15/04; B05D 3/02

(52) U.S. Cl. 428/469; 427/376.2; 427/126.3

(57) ABSTRACT

A refractory coating is provided for a component of an electrolytic cell for the production of aluminum in which an aqueous slurry is prepared comprising particulate refractory material, e.g. TiB₂, dispersed in an aluminum oxalate complex. The slurry is applied as a coating to the surface of the component, e.g. a cathode block, and dried to form a hard refractory surface on the component. The aluminum oxalate complex may be formed in situ during production of the slurry by mixing together oxalic acid and electrostatic precipitator dust comprising aluminum oxide. After the refractory coated component is immersed in a high temperature cryolite bath of an aluminum electrolysis cell, the aluminum oxalate complex is converted to alumina which bonds the refractory particles to the surface of the cell component.

### Background of the Invention

1. Field of the Invention

This invention relates to the production of refractory coatings for use in cells for the production of aluminum by the electrolysis of alumina dissolved in a molten electrolyte, such as cryolite or other fluoride-based electrolytes. The invention more specifically relates to a slurry for producing the refractory coatings, as well as cell components coated with the refractory material. This application claims the benefit of U.S. Provisional Application No. 60/183,063, filed Feb. 16, 2000.

2. Background of the Invention

The manufacture of aluminum is conducted conventionally by the Hall-Heroult electrolytic reduction process, whereby alumina is dissolved in molten cryolite and electrolyzed at temperatures of about 900 to 1000° C. This process is conducted in a reduction cell typically comprising a steel shell provided with an insulating lining of suitable refractory material, which is in turn provided with a lining of carbon which contacts the molten constituents. One or more anodes, typically made of carbon, are connected to the positive pole of a direct current source, and suspended within the cell. One or more conductor bars connected to the negative pole of the direct current source are embedded in the carbon cathode substrate comprising the floor of the cell, thus causing the cathode substrate to become cathodic upon application of current. The carbon lining is typically constructed from array of prebaked cathode blocks, rammed together with a mixture typically of anthracite, coke, and coal tar pitch.

In this conventional design of the Hall-Heroult cell, the molten aluminum pool or pad formed during electrolysis itself acts as part of the cathode system. The life span of carbon lining or cathode material may typically average about 3 to 8 years, but may be shorter under adverse conditions. The deterioration of the carbon lining material is due to erosion and penetration of electrolyte and liquid aluminum as well as intercalation by metallic sodium, which causes swelling and deformation of the carbon blocks and ramming mixture.

It has long been recognized that it would be desirable to coat the carbon lining and cathode material of an aluminum electrolysis cell with a refractory material, such as titanium diboride, that would render the carbon surface wettable to molten aluminum and which in turn would lead to a series of advantages. Research on refractory hard material, such as titanium diboride, for this purpose has been carried out since the 1950's.

Numerous patents have been granted on this technology and, for instance, Boxall et al. U.S. Pat. No. 4,624,766 describes an aluminum wettable, cured, carbonized cathode material for use in aluminum electrolysis cells which comprises a hard refractory material in a carbonaceous matrix which includes a carbonaceous filler and carbon fiber bonded by a non-graphitized amorphous carbon, this matrix having a rate of ablation essentially equal to the rate of wear and dissolution of the refractory hard material in the operating environment of the cell.

Sekhar et al. WO 98/17842 published Apr. 30, 1998 describes a method for applying a refractory boride to components of an aluminum electrolysis cell by forming a slurry of particulate preformed refractory boride in at least two grades of colloidal carriers selected from the group consisting of colloidal alumina, yttria, ceria, thoria, zirconia, magnesia, lithia, monoaluminum phosphate, cerium acetate and mixtures thereof, the two colloidal carriers preferably each being of the same colloid, followed by drying. The two grades of colloidal carrier have mean particle sizes which differ from one another by about 10-50 nanometers.

A readily available source of aluminum oxide can be found in electrostatic precipitator (ESP) dust that is recovered from alumina calcining plants. This dust typically contains about 70-80% anhydrous Al₂O₃ and 20-30% hydrated Al₂O₃.

### SUMMARY OF THE INVENTION

It is an object of the invention to provide a method of treating a carbonaceous component of an electrolysis cell for the production of aluminum, to improve the resistance of the component to deterioration during operation of the cell by providing wetting properties and erosion resistance.

It is a further object of the invention to provide refractory coatings for components of an electrolytic cell for the production of aluminum which coatings are both inexpensive and effective.

It is a still further object to be able to make use of electrostatic precipitator dust in the production of the refractory coatings.

According to one main aspect of the invention, a method of applying a refractory coating to a component of an electrolytic cell for the production of aluminum comprises preparing an aqueous slurry of particulate refractory material dispersed in a metal oxalate complex, e.g. an aluminum oxalate complex. This slurry is then applied as a coating to the surface of the cell component and dried to form a hard refractory surface on the component.

The aluminum oxalate complexes may be formed by combining oxalic acid with an aluminum oxide or other aluminum compound. For instance, oxalic acid may be heated with AlCl₃ 6H₂O to form H[Al(C₂O₄)₂], and/or Hₙ₊₂(Al_{n(C}₂O₄)₂ₙ₊₁, n=1 or 2, with liberation of HCl. The oxalic acid may also be heated with aluminum hydroxide to give Al₂(C₂O₄)₃, H[Al(C₂O₄)₂] and/or Hₙ₊₂(Alₙ(C₂O₄)₂ₙ₊₁, n=1 or 2. Heating oxalic acid with H10 hydrate (dried aluminum hydrate from Bayer plant having formula Al₂O₃3 H₂O) provides H[Al(C₂O₄)₂] and/or Hₙ₊₂(Alₙ(C₂O₄)₂ₙ₊₁, n=1 or 2. Also, Na₃[Al(C₂O₄)₃ ] may be passed through a cation exchange resin to form H₃[Al(C₂O₄)₃].

It has been found to be particularly advantageous to form the aluminum oxalate complex from oxalic acid and electrostatic precipitator dust comprising aluminum oxide. Electrostatic precipitator dust is finely divided aluminum oxide that has been recovered from alumina calcining plants. A typical composition comprises about 70-80% anhydrous Al₂O₃ and 20-30% hydrated Al₂O₃.

Whether the complexes are formed using electrostatic precipitator dust or other sources of aluminum, best results are obtained if the slurry of particulate refractory material is formed only a short time before use, e.g. less than 4 hours. The oxalate complex serves as a binder-dispersant for the particulate refractory material and as a bonding material to bond the refractory material to cell component prior to immersion into the cryolite bath of the electrolytic cell. After the coating containing oxalate complex has been exposed to the high temperature conditions in the cryolite bath, the oxalate complex breaks down into aluminum oxide. Thus, in actual use within the electrolysis cell, it is aluminum oxide that binds the refractory particles together and to the cathode.

According to a particularly preferred embodiment, oxalic acid and electrostatic precipitator dust are mixed with a particulate refractory material to form a coating slurry with the aluminum oxalate complex being formed in situ during the mixing. The particulate refractory material is preferably a particulate boride material, e.g. zirconium, vanadium, hafnium, niobium, tantalum, chromium or molybdenum boride. Titanium diboride is particularly advantageous because of its lower cost and high resistance to oxy-fluoride melts and molten aluminum.

The slurry used for applying the coating typically contains about 30-90% by weight preferably about 50-70% by weight, of refractory material, e.g. titanium diboride. For forming a preferred slurry, oxalic acid and electrostatic precipitator dust are combined in the ratio of about 3:1 to 1:1. The slurry is applied to form a coating having a thickness of at least 1 mm, preferably 5-15 mm, and most preferably 8-12 mm. The application can be by a variety of means such as spraying, rolling, etc.

The refractory hard materials for use in this invention typically have a particle size of 5-30 μm, preferably 10-20 μm. The electrostatic precipitator dust is typically a very small particle size material, e.g. <5 μm.

### EXAMPLE 1

A coating slurry was prepared by mixing together 16% by weight water, 14% by weight solid oxalic acid, 65% by weight TiB₂ particles and 5% by weight electrostatic precipitator dust. There was an exothermic reaction during mixing.

This slurry was sprayed onto 5 cm×7 cm×2 cm cathode block to a thickness of 1-2 mm. The coated block was then heated for 10 minutes to dry the coating.

The refractory coated cathode block was then placed in a laboratory electrolysis cell with a space of 3 cm between the anode and cathode. The bath contained NaF and NaF and AlF₃ in the ratio of 1.25:1 and was held at a temperature of 960° C. A 30 ampere direct current at 2.8 volts was applied and alumina was fed into the bath in an amount of 27 g over 2.5 hours.

The test was continued for a period of 24 hours, at which time the total surface of the cathode was wetted by aluminum.

### EXAMPLE 2

Following the same procedure as in Example 1, a coating slurry was prepared containing 15% by weight water, 10% by weight solid oxalic acid, 65% by weight TiB₂ particles and 10% by weight electrostatic precipitator dust. The slurry was sprayed onto 5 cm×7 cm×2 cm cathode block to a thickness of 1-2 mm. The coated block was then heated for 10 minutes to dry the coating.

The refractory coated block was tested in a laboratory electrolysis cell in the same manner as in Example 1 with the bath at a temperature of 966° C. The test was terminated after 24 hours, at which time the total surface of the cathode was wetted by aluminum.

### EXAMPLE 3

For this test, a coating slurry was prepared by mixing together 25% by weight of a 15% oxalic acid solution, 65% by weight TiB₂ particles and 10% by weight electrostatic precipitator dust. During the mixing, the slurry was sprayed onto 5 cm×7 cm×2 cm cathode block to a thickness of 1-2 mm. The coated block was then heated for 10 minutes to dry the coating.

The refractory coated block was then tested in a laboratory electrolysis cell in the same manner as in Example 1 with the bath at a temperature of 970° C. The test was terminated after 24 hours, at which time the total surface of the cathode was wetted by aluminum.

1. A method of applying a coating of refractory material to a component of an electrolytic cell for the production of aluminum,
the method comprising preparing an aqueous slurry of particulate refractory material dispersed in a metal oxalate complex, applying a coating of the slurry to the surface of the component and drying to form a hard refractory surface on the component.

2. A method according to claim 1 wherein the metal oxalate complex is an aluminum oxalate complex.

3. A method according to claim 2 wherein the aluminum oxalate complex is formed from oxalic acid and electrostatic precipitator dust comprising aluminum oxide.

4. A method according to claim 3 wherein the aluminum oxalate complex is formed in situ.

5. A method according to claim 2 wherein the aluminum oxalate complex is formed no more than 4 hours before being mixed with the particulate refractory material.

6. A method according to claim 1 wherein the particulate refractory material is a particulate boride material.

7. A method according to claim 6 wherein the boride is zirconium, vanadium, hafnium, niobium, tantalum, chromium or molybdenum boride.

8. A method according to claim 6 wherein the boride is titanium boride.

9. A method according to claim 8 wherein the slurry contains about 30-90% by weight titanium boride.

10. A method according to claim 3 wherein the oxalic acid and electrostatic precipitator dust are combined in the ratio of 3:1 to 1:1.

11. A method according to claim 6 wherein the coating is applied to a thickness of at least 1 mm.

12. A method according to claim 11 wherein the coating is applied to a thickness of about 5-15 mm.

13. A method according to claim 11 wherein the particulate boride material has particle sizes in the range of 5-30 μm.

14. A method according to claim 2 wherein the coated cell component is utilized in a high temperature cryolite bath and the oxalate complex in the coating breaks down in the high temperature condition of the bath to form aluminum oxide and 20-30% hydrated Al₂O₃.

15. A method according to claim 10 wherein the electrostatic precipitator dust contains about 70-80% anhydrous Al₂O₃.

16. A method according to claim 1 wherein the cell component is a cathode block.

17. A component of a cell for the production of aluminum by the electrolysis of alumina dissolved in a cryolite-based molten electrolyte, which cell component is coated with a refractory material according to the method of claim 1.

18. A coated component according to claim 17 wherein the coating comprises particulate refractory material dispersed in an aluminum oxalate complex.

19. A coated component according to claim 18 wherein the aluminum oxalate complex is obtained from oxalic acid and electrostatic precipitator dust comprising aluminum oxide.

20. A coated component according to claim 19 wherein the particulate refractory material is a particulate boride material.

21. A coating component according to claim 20 wherein the boride is zirconium, vanadium, hafnium, niobium, tantalum, chromium or molybdenum boride.

22. A coated component according to claim 20 wherein the boride is titanium boride.

23. A coated component according to claim 21 wherein the coating has a thickness of at least 1 mm.

24. A coated component according to claim 23 wherein the coating has a thickness of about 5-15 mm.

25. A coated component according to claim 17 wherein the cell component is a cathode block.

26. A coated component according to claim 21 which has been immersed in a high temperature cryolite bath.

27. A coating composition for use in applying a coating of refractory material to a component of an electrolytic cell for the production of aluminum, comprising an aqueous slurry of particulate refractory material dispersed in a metal oxalate complex.

28. A coating composition according to claim 28 wherein the metal oxalate complex is an aluminum oxalate complex.

29. A coating composition according to claim 28 wherein the aluminum oxalate complex is formed from oxalic acid and electrostatic precipitator dust comprising aluminum oxide.

30. A coating composition according to claim 29 wherein the particulate refractory material is a particulate boride material.

31. A coating composition according to claim 30 wherein the boride is titanium boride.
